(19) United States
(12) Patent Application Publication
(10) Pub. No.: US 2007/0169091 A1
(43) Pub. Date: Jul. 19, 2007

(54) Control device and method of effective use of storage device

(75) Inventors: Naoki Shigeno, Niigata (JP); Osamu Fujinawa, Niigata (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Minato-ku (JP)

(21) Appl. No.: 11/475,067

(22) Filed: Jun. 27, 2006

(30) Foreign Application Priority Data
Dec. 9, 2005 (JP) 2005-355940

(51) Int. Cl. G06F 9/44

(52) U.S. Cl. 717/168

(57) ABSTRACT

A control device which has a memory that stores a program, and a controller that deletes the program stored in the memory after the program is executed.

### CROSS-REFERENCE TO RELATED APPLICATION

This application claims priority under 35 U.S.C. 119 from Japanese Patent Application No. 2005-355940, the disclosure of which is incorporated by reference herein.

### BACKGROUND ART

1. Technical Field

The present invention relates to a control device which mounts a storage device and a method of effective use of the storage device, and more particularly to a control device which enables to efficiently use a storage region of the storage device and a method of effective use of the storage device.

2. Related Art

A storage device such as a flash memory or a RAM (random access memory) which is mounted on a control board stores control programs and various types of setting information for realizing functions and is invoked and executed by a central processor unit which is also mounted on the control board. These control programs and various types of setting information are invoked and executed by the central processor unit if necessary. They include control programs which are always executed at the time of startup, setting information which is always referenced and control programs for executing particular functions and executed by a special processing only; and data stored in the storage device have a different frequency of use.

They include control programs which are used only once, and when such control programs are executed once, they are not used again and remain to simply occupy the capacity of the storage device.

There are also control programs which are allowed to be used only once, and prescribed processing is performed such that such control programs cannot be executed again when they are executed once. For example, a flag which sets the usability of the control program is provided so that the usability is judged at the time of instructing the execution of the control program by referring to the flag.

All the above control programs (the control programs executed only once and those which are caused to execute only once) become unnecessary after they are executed. These control programs sometimes disturb other control programs in one instance and often become a cause of lowering a searching speed of the storage device.

There is a related art disclosed in Japanese Patent Application Laid-Open No.

2005-31812 that provides an image forming apparatus which makes a user use necessary functions only without waste by optionally purchasing necessary functions depending on a state of use by the user.

According to the related art disclosed in Japanese Patent Application Laid-Open No. 2005-31812, it is made possible to continuously use prescribed functions by providing a printer with a key such as a print enabler key or a scan enabler key registered in a USB memory.

But, the related art described in Japanese Patent Application Laid-Open No. 2005-31812 enables to use continuously a prescribed function by providing the print enabler key or the scan enabler key and restricts the use by denying the use of a function which is not provided with the key, but a processing program for realizing the function of which use is denied and other related data remain in the storage region, and the state of use of the storage region does not change. And, the function of which use is refused becomes reusable by purchasing an option. Thus, its object is quite different from the present invention.

Where the control programs stored in the storage device are control programs which are used for inspection such as an operation diagnosis performed at the time of shipping the products, they are not used by the user after the shipping of the products, so that the storage of such control programs is meaningless. And, in a case where the product is shipped with the control programs installed and the control programs are executed by an unauthorized program, there is a possibility that data is broken, a failure takes place, or the like.

### SUMMARY

An aspect of the present invention provides a control device which includes a memory that stores a program and a controller that deletes the program stored in the memory after the program is executed.

### BRIEF DESCRIPTION OF THE DRAWINGS

An exemplary embodiment of the present invention will be described in detail based on the following figures, wherein:

FIG. 1 is a structure diagram of a control device in which a method of effective use of a storage device is applied according to an exemplary embodiment of the invention;

FIG. 2 is a flowchart showing a flow of processing by the control device and the method of effective use of the storage device according to the exemplary embodiment of the invention;

FIG. 3 is a structure diagram of another control device in which the method of effective use of the storage device is applied according to the exemplary embodiment of the invention;

FIG. 4 is a flowchart showing a flow of processing in the structure of the control device shown in FIG. 3;

FIG. 5 is another flowchart showing a flow of processing in the structure of the control device shown in FIG. 3; and

FIG. 6 is a flowchart showing a flow of processing for executing a rewriting program stored in FIG. 5.

### DETAILED DESCRIPTION

A control device and a method of effective use of a storage device according to an exemplary embodiment of the invention will be described in detail with reference to the accompanying figures.

In the following exemplary embodiment, it is configured to delete control programs stored in a flash memory by executing a prescribed program, but the configuration is not limited to it but can also be applied to even a storage medium such as a ROM, which cannot be written by controlling from a CPU, by executing the invention using a special device in the production process.

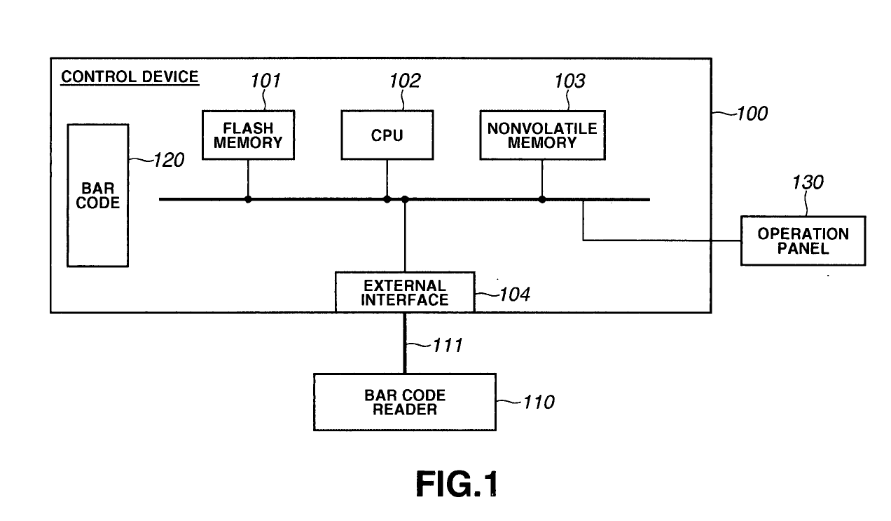

FIG. 1 is a structure diagram of a control device in which a method of effective use of a storage device is applied according to an exemplary embodiment of the invention

In FIG. 1, a control device 100 has a flash memory 101, a CPU (central processor unit) 102, a nonvolatile memory 103 and an external interface 104. A bar code reader 110 is connected through a communication line 111 via the external interface 104, and an operation panel 130 for checking data is connected to the control device 100.

The control device 100 indicates a control board which is mounted on a device.

Besides, recording paper on which a bar code 120 is printed is stuck to the control device 100, and the bar code 120 can be read by the bar code reader 110.

By using the above configuration, board specific information for uniquely identifying the control device 100 is stored in the nonvolatile memory 103, and the control program used for storing is deleted. The board specific information here is a board name or a physical address which is identified on a network.

The flash memory 101 stores control programs for various types of functions to be realized by a device which mounts the control device 100, e.g., a device such as a printer or a multifunctional device, and also stores a “storage control program” to store the board specific information indicated by the bar code read by the bar code reader 110 into the nonvolatile memory 103.

And, it stores a “deletion control program” for deleting the storage control program used to store the board specific information, and it is a control program to be executed after it is checked that the board specific information is properly stored in the nonvolatile memory 103 after the storage control program is executed. It may be configured not to store the deletion control program in the flash memory 101 but to store in an expanded state in the buffer of the CPU 102.

The CPU 102 performs main control of the control device 100 and executes various types of control programs stored in the flash memory 101 and the nonvolatile memory 103. It also recognizes the bar code reader 110 or a rewriting device (not shown) which is connected via the external interface 104 and performs processing of the contents of the bar code read by the bar code reader 110.

The board specific information indicated by the read bar code is stored in the nonvolatile memory 103 by executing the storage control program stored in the flash memory 101. And, when the stored board specific information is shown on the operation panel 130 and checked by a user that it is appropriately stored, the deletion control program stored in the flash memory 101 is executed to delete the storage control program.

The nonvolatile memory 103 is a storage device such as an EEPROM (electronically erasable and programmable read only memory) or the like, and information therein is electrically rewritable. This nonvolatile memory 103 stores the board specific information indicated by the bar code read by the bar code reader 110.

The board specific information stored in its storage region allows reading only but denies rewriting. In other words, it is read-only information and cannot be updated newly. And, this board specific information can be rewritten only by the rewriting program received from a prescribed rewriting device.

The external interface 104 is a communication interface for connecting the control device 100 with another device and can be connected with another device by the communication line 111 such as a USB (universal serial bus) cable or a LAN (local area network) cable. The device to be connected via the external interface 104 includes the bar code reader 110 for reading a bar code, a prescribed rewriting device for resetting the board specific information, and the like, and the received data is processed under control by the CPU 102.

The bar code reader 110 is recognized when it is connected to the control device 100 configured as described above through the communication line 111, and the board specific information indicated by the bar code read by the bar code reader 110 can be stored in the nonvolatile memory 103 by executing the storage control program stored in the flash memory 101.

Besides, the operation panel 130 is a display device capable of showing data stored in the flash memory 101 and the nonvolatile memory 103 and especially displays the board specific information stored in the nonvolatile memory 103.

When it is checked with the use of the operation panel 130 that the board specific information is stored in the nonvolatile memory 103, the deletion control program stored in the flash memory 101 is executed to delete the storage control program used for storing the board specific information from the flash memory 101.

According to the configuration as described above, the storage control program which is used only one time according to initialization or the like can be deleted from the nonvolatile memory, so that the storage region can be used effectively, and the misuse of the control program can be prevented.

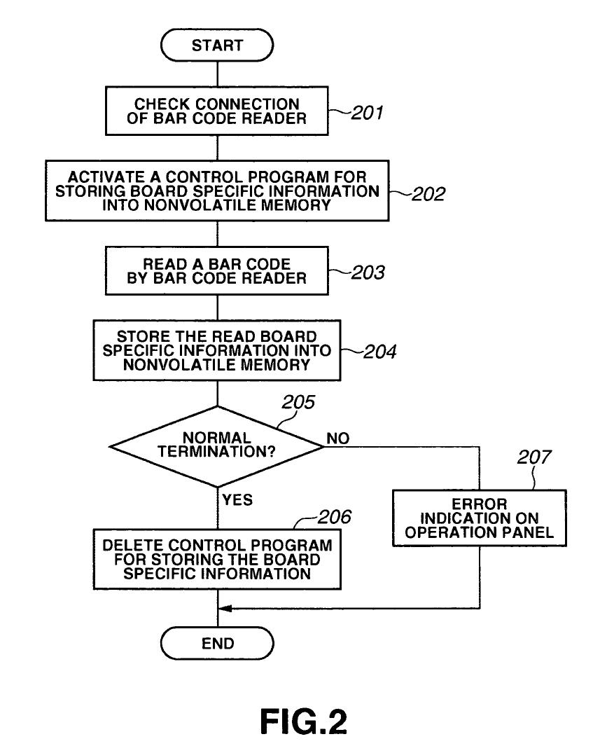

FIG. 2 is a flowchart showing a flow of processing by the control device and by the method of effective use of the storage device according to the exemplary embodiment of the invention.

In FIG. 2, processing is started when the bar code reader is connected to the external interface of the control device, and connection check of the connected bar code reader is performed (201). When the bar code reader is recognized by the connection check, the storage control program stored in the flash memory is activated to store the board specific information read by the bar code reader (202).

When the activation of the storage control program is checked as a display lamp of the bar code reader lights up or the like and it becomes ready to read the board specific information, the bar code reader is used to read a bar code (203). The bar code is stuck to, for example, a prescribed part of the control device, and the bar code is read. It may also be configured such that a list of bar codes is separately prepared for reading.

When the bar code is read by the bar code reader, the board specific information indicated by the read bar code is stored in a prescribed storage region of the nonvolatile memory via the external interface (204). Then, it is checked with reference to the information indicated on the operation panel whether or not the board specific information is normally stored in the prescribed position of the nonvolatile memory (205). If it is stored normally (readable normally) (YES in 205), the deletion control program stored in the flash memory is started and executed to delete the storage control program stored in the flash memory (206).

If not stored properly because of defective reading or the like (NO in 205), that effect is indicated as an error on the operation panel (207).

According to the flow of processing described above, the storage control program for storing the board specific information becomes not present in the flash memory, a change in the board specific information can be prevented, and the storage region where the storage control program is stored becomes reusable.

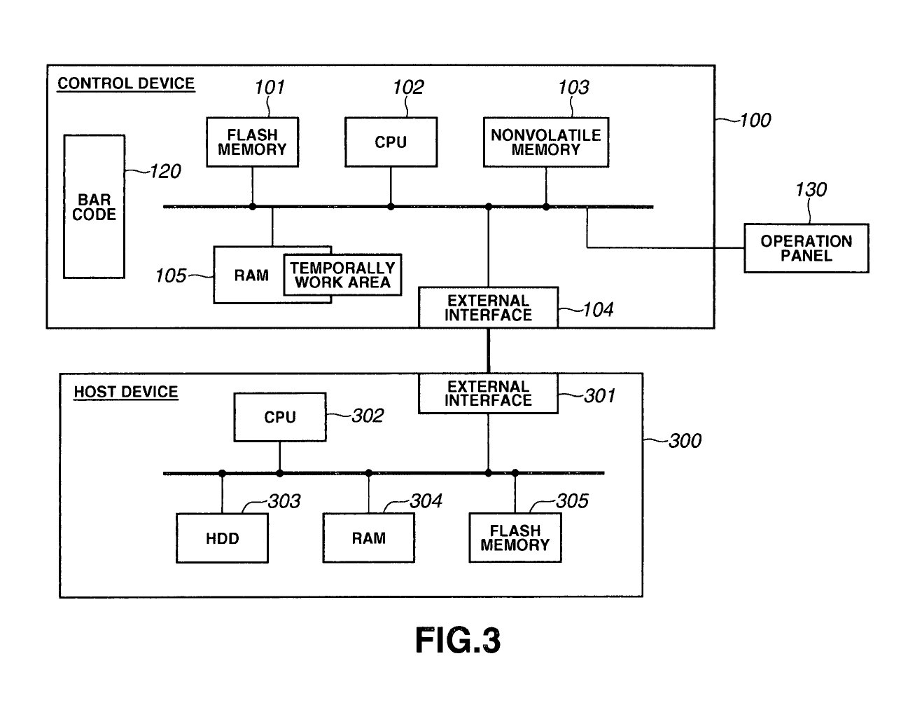

FIG. 3 is a structure diagram of another control device in which the method of effective use of the storage device is applied according to the exemplary embodiment of the invention.

FIG. 3 shows a structure that the control device 100 and a host device 300 are connected by a communication line. The control device 100 has the flash memory 101, the CPU 102, the nonvolatile memory 103, the external interface 104 and a RAM 105, and the host device 300 has an external interface 301, a CPU 302, a HDD (hard disk drive) 303, a RAM 304 and a flash memory 305.

The host device 300 has a function to rewrite the board specific information stored in the nonvolatile memory 103 and is also called as a rewriting device.

First, the control device 100 has a structure similar to that shown in FIG. 1, so that only differences will be described.

The RAM 105 is added to the control device 100 shown in FIG. 1 and used as a storage region for temporarily storing the control program when a type of the control program received from the host device 300 is judged by the CPU 102.

And, the flash memory 101 stores, in addition to the control program explained with reference to FIG. 1, a rewriting program which is stored in the RAM 1 OS when the host device 300 is verified by the CPU 102. This rewriting program is a control program for rewriting the board specific information which is stored in the nonvolatile memory 103, and used for inspection of the devices or dealing with a failure at a manufacturer.

This rewriting program is a control program which is sent from a prescribed rewriting device when the prescribed rewriting device is connected via the external interface 104. The rewriting program is stored only when it is recognized that the connected device is the prescribed rewriting device and the password authentication can be performed.

It may also be configured such that, instead of recognition of the connected rewriting device, a rewriting program, to which information capable of identifying a type of the program is added, is obtained from the rewriting device and stored in a buffer region, and it is compared to see whether or not the stored rewriting program is the storage control program deleted by the deletion control program, and only if they coincide, the rewriting program is stored.

And, the CPU 102 verifies the connected host device 300, and temporarily stores the rewriting program in the RAM 105 if the connected host device 300 is verified. Referring to the information for identification of the program added to the rewriting program, it is judged whether or not it is the storage control program used when the board specific information is set in the nonvolatile memory 103.

When it is the rewriting program equivalent to the storage control program, password authentication is performed to store the rewriting program from the host device 300 into the flash memory 101. When the password authentication is performed, the rewriting program temporarily stored in the RAM 105 is stored into the flash memory 101. If the password authentication fails, the rewriting program stored in the RAM 105 is deleted.

Then, the rewriting program is executed to rewrite the board specific information stored in the nonvolatile memory 103. When the rewriting is completed, the deletion control program stored in the flash memory 101 is executed to delete the rewriting program stored in the flash memory 101.

The host device 300 is a special terminal which is configured by an inspection PC, a particular board specific information rewriting hardware or the like, and the external interface 301 of the host device 300 is a communication interface which is connected to the external interface 104 of the control device 100 by a communication line.

The CPU 302 performs main control of the host device 300 and, when the external interface 301 is connected to the control device 100, transmits the rewriting program stored in the HDD 303 to the control device 100.

The HDD 303 is a hard disk drive and stores the control program of the host device 300. Especially, it stores the rewriting program which rewrites the board specific information stored in the nonvolatile memory 103 of the control device 100. When it is connected to the control device 100, the CPU 302 transmits the rewriting program to the control device 100 via the external interface 301.

The rewriting program is provided with a program header, which stores various types of information such as an identifier indicating a type of the program, a data size and priority. And the control device 100 realizes various processings by referring to such information.

The RAM 304 is a storage device which provides a work area for the CPU 302 and a work area of the control program executed by the CPU 302.

The flash memory 305 is a storage device for storing various types of control programs and stores a communication control program which establishes communications with the control device 100 via the external interface 301 and a transmission program which sends the rewriting program stored in the HDD 303 in response to a request. In response to a communication control program execution instruction from the CPU 302, connection with the control device 100 is established, and the rewriting program is sent.

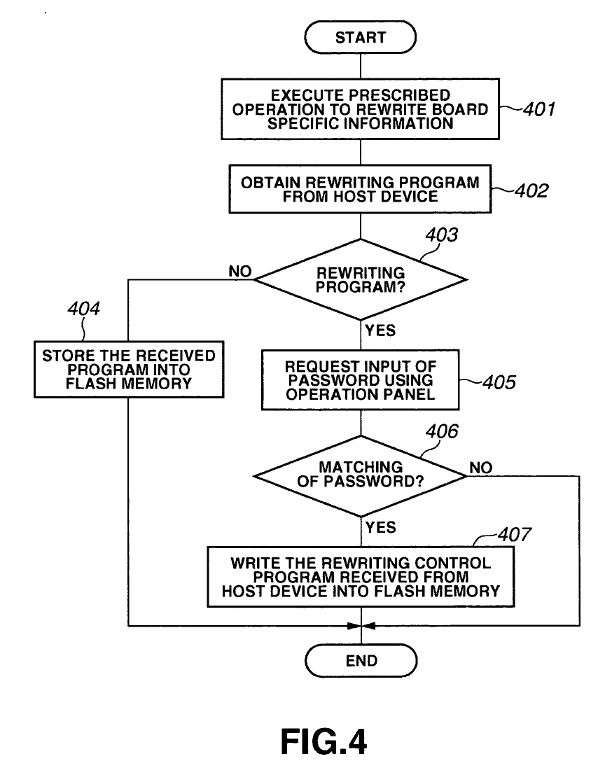

By configuring as described above, when resetting the board specific information which is set in the nonvolatile memory 103 of the control device 100, the connection between the control device 100 and the host device 300 is checked, the rewriting program is transferred from the host device 300 to the control device 100, the rewriting program is executed by the control device 100, and it becomes possible to rewrite the board specific information stored in the nonvolatile memory 103. A flow of processing for the above resetting of the board specific information is shown in FIG. 4.

FIG. 4 is a flowchart showing a flow of processing in the structure of the control device shown in FIG. 3.

In FIG. 4, a prescribed operation such as power-on is performed while pressing a particular operation button for rewriting the board specific information (401) to execute a rewrite-control program stored in the flash memory so as to permit rewriting of the board specific information. When rewriting is permitted, a rewriting program for rewriting the board specific information is obtained from the host device, e.g., an inspection PC which is connected via the external interface (402). The obtained rewriting program is stored into a temporary work area of the RAM and executed by the CPU.

An identifier capable of identifying the processing contents of the program is added to the rewriting program, and a type of the obtained control program is identified by referring to the identifier.

The type of the obtained control program is checked by the identifier to judge whether or not it is a rewriting program capable of rewriting the board specific information (403), and if it is not a rewriting program (NO in 403), it is judged as ordinary data and stored in the flash memory (404). Meanwhile, when it is judged that a rewriting program has been received (YES in 403), input of a password from the operation panel is requested in order to store the rewriting program into the flash memory and execute it (405).

When a password is input by the user, it is judged whether or not the password is correct (406), if the password cannot be judged correct (NO in 406), that effect is displayed on the operation panel, and the processing is terminated. If the password is correct (YES in 406), the received rewriting program is written into the flash memory (407).

In the rewriting program writing process, a special writing process is performed by the connected host device, so that it becomes possible to write into the flash memory.

According to the above flow of processing, the rewriting program for resetting the board specific information can be stored into the flash memory of the control device, and it becomes possible to reset the board specific information.

Then, processing in a case where the storage region of the flash memory 101 is full when the rewriting program explained with reference to FIG. 4 is to be stored will be described with reference to FIG. 3.

A compression-expansion control program is newly stored into the flash memory 101 of the control device 100 shown in FIG. 3.

Upon receiving the rewriting program from the connected host device 300, the CPU 102 calculates a remainder storage capacity of the flash memory 101 and, if the storage capacity is insufficient for storage of the rewriting program, executes the compression-expansion control program stored in the flash memory 101 to compress the data stored in the flash memory 101.

The rewriting program is stored in a free space produced by the above compression.

Besides, when the board specific information stored in the nonvolatile memory 103 is rewritten by executing the rewriting program and the rewriting program is deleted by the deletion control program stored in the flash memory 101, the compression-expansion control program is executed again to expand the compressed data in the flash memory 101.

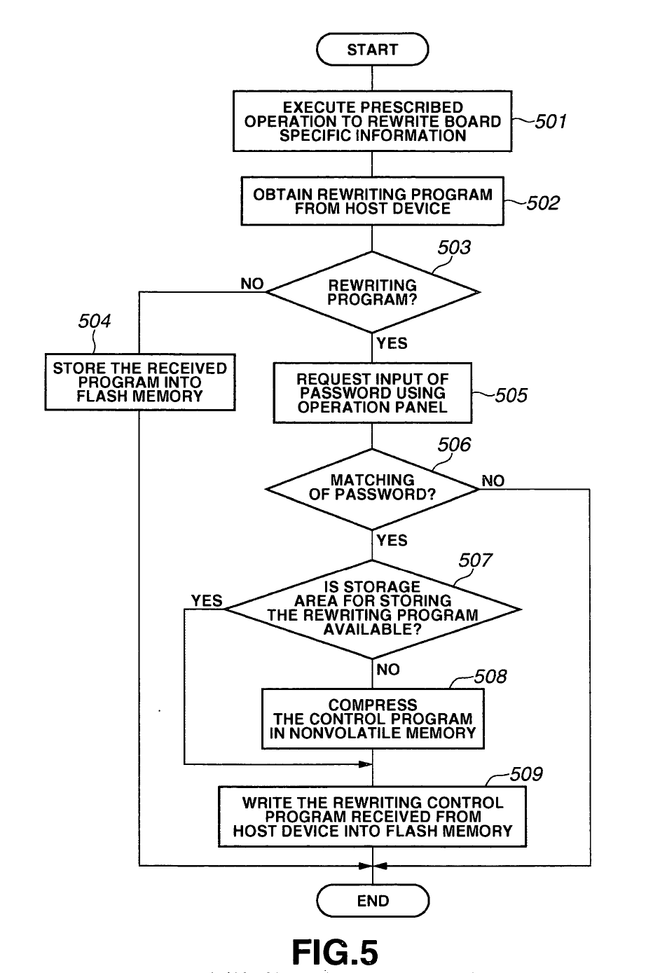

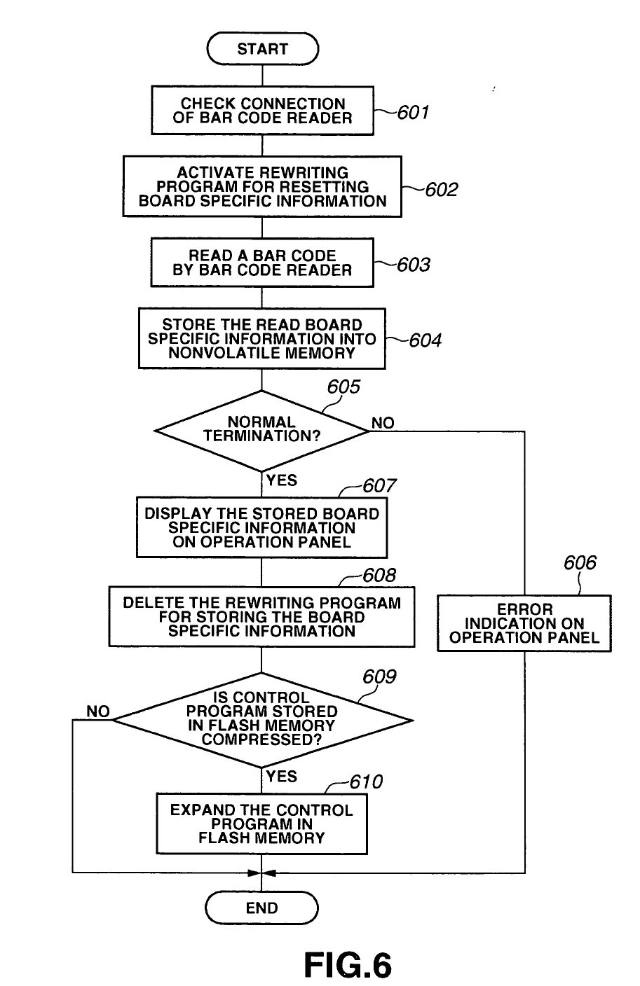

A flow of the above processing will be described with reference to the flowcharts of FIG. 5 and FIG. 6.

FIG. 5 is another flowchart showing a flow of processing in the structure of the control device shown in FIG. 3.

In FIG. 5, a prescribed operation is performed to rewrite the board specific information (501), and the rewrite-control program stored in the flash memory is executed to permit rewriting of the board specific information. When the rewriting is permitted, a rewriting program for rewriting the board specific information is obtained from the host device, for example, an inspection PC, which is connected via the external interface (502). The obtained rewriting program is stored into a temporary work area of the RAM and executed.

The rewriting program is provided with an identifier capable of identifying the processing contents of the program, and a type of the program is discriminated by referring to the identifier.

The obtained type of the control program is checked by the identifier to judge whether or not it is a rewriting program capable of rewriting the board specific information (503) and, if it is not a rewriting program (NO in 503), it is judged as ordinary data and stored into the nonvolatile memory (504). On the other hand, when it is judged that the rewriting program has been received (YES in 503), input of a password from the operation panel is requested in order to execute the rewriting program (505).

When the password is input by the user, it is judged whether or not the password is correct (506) and, if it cannot be judged as a correct password (NO in 506), that effect is displayed on the operation panel, and the processing is terminated. If the password is correct (YES in 506), it is judged whether or not a particular storage region for storing the received rewriting program is secured in the flash memory (507).

If there is no storage region for storing the obtained rewriting program (NO in 507), writing cannot be made, so that it is necessary to secure its storage region. Accordingly, the control programs already stored in the nonvolatile memory are compressed to secure a storage region (508). The control programs to be compressed may be the entire control programs or may be part of the control programs stored in the nonvolatile memory.

Where the control programs are partly compressed, it may be configured to compress starting from a control program having the largest data size or to compress starting from a control program having a form with a high compression efficiency.

Regardless of whether a free area capable of storing the rewriting program is available (YES in 507) or a storage region is secured by compression (NO in 507), the obtained rewriting program is written into the flash memory (509).

By the above processing, the rewriting program for rewriting the board specific information can be stored into the flash memory.

The rewriting program at this time is a control program capable of storing into the nonvolatile memory the board specific information indicated by the bar code read by the bar code reader similar to the storage control program explained with reference to FIG. 1 or FIG. 2 and also a control program that judges whether or not the data stored in the flash memory is compressed.

In other words, the rewriting program includes the processing contents of the storage control program.

FIG. 6 is a flowchart showing a flow of processing for executing the rewriting program stored in the processing shown in FIG. 5.

In FIG. 6, processing is started when the bar code reader is connected to the external interface of the control device, and the connection of the connected bar code reader is checked (601). When the connection of the bar code reader is confirmed by the connection check, the rewriting program for resetting the board specific information obtained by the processing shown in FIG. 5 is started (602).

When the start of the rewriting program is checked as the display lamp of the bar code reader lights up or the like and it becomes ready to read the board specific information, the bar code reader is used to read the bar code (603). When the bar code is read by the bar code reader, the board specific information indicated by the read bar code is stored in a prescribed storage region of the nonvolatile memory via the external interface (604). Then, board specific information reading processing or the like is performed to check whether or not the board specific information is normally stored into the prescribed position of the nonvolatile memory (605) and, if the board specific information is not stored normally (NO in 605), an error indication is made on the operation panel to display that the storage has not been made normally (606), and the processing is terminated.

If stored normally (reading can be made normally) (YES in 605), the stored board specific information is displayed on the operation panel of the control device (607).

When the board specific information is stored normally and displayed on the operation panel, the deletion control program stored in the flash memory is activated and executed to delete the rewriting program used to reset the board specific information (608).

At this time, it is judged whether various control programs stored in the flash memory are in a compressed state for storage of the rewriting program (609) and, if they are in a compressed state (YES in 609), the control programs in the compressed state are expanded (610). And, if they are not compressed (NO in 609), the processing is terminated as it is.

Thus, it is made possible to reset the board specific information, and the control program structure before the rewriting program is stored into the flash memory can be reproduced.

Through the above processing, the control device of the invention can delete the unnecessary control programs from the storage device. And, the processing can be reproduced by re-storing the deleted control programs.

It is to be noted that the present invention is not limited to the exemplary embodiment described above and shown in the drawings, and other changes and modifications may be made without departing from the scope of the invention.

For example, in the above exemplary embodiment, it is configured to store into the flash memory the storage control program for storing the board specific information and the rewriting program for resetting the board specific information by connecting the host device, but it may be configured to store the programs to be deleted by the deletion control program into the nonvolatile memory.

Besides, it may be configured such that a special device, e.g., a device for writing a prescribed control program into a storage medium such as a ROM, is used instead of the host device shown in FIG. 3 in the production process to delete the control program stored in the ROM.

The present invention can be applied to a storage device which can efficiently use the storage region, and it is especially useful to enable to delete from the storage device a control program which is used only one time and also obtain it from a prescribed device, if necessary.

The foregoing description of the exemplary embodiment of the present invention has been provided for the purpose of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. A control device, comprising:
a memory that stores a program; and
a controller that deletes the program stored in the memory after the program is executed.

2. A control device having a nonvolatile memory in which inherent data is written, comprising:
a memory in which a plurality of control programs including a write-control program for writing the inherent data into the nonvolatile memory are stored; and
a controller that deletes the write-control program stored in the memory after the inherent data is stored into the nonvolatile memory by execution of the write-control program.

3. The control device according to claim 1, wherein:
the memory compresses and stores control programs other than the write-control program; and
the controller is provided with an expansion controller that expands the other compressed control programs and stores into the memory after the write-control program is deleted.

4. The control device according to claim 2, wherein:
the memory compresses and stores control programs other than the write-control program; and
the controller is provided with an expansion controller that expands the other compressed control programs and stores into the memory after the write-control program is deleted.

5. The control device according to claim 1, wherein the memory is provided with a rewriting portion that rewrites the write-control program deleted by the controller into the memory.

6. The control device according to claim 2, wherein the memory is provided with a rewriting portion which rewrites the write-control program deleted by the controller into the memory.

7. The control device according to claim 3, wherein the memory is provided with a rewriting portion which rewrites the write-control program deleted by the controller into the memory.

8. The control device according to claim 4, wherein the memory is provided with a rewriting portion which rewrites the write-control program deleted by the controller into the memory.

9. The control device according to claim 1, wherein the controller is provided with a compression controller that compresses the other control programs to secure a storage region for the write-control program when the write-control program is rewritten by the rewriting portion.

10. The control device according to claim 2, wherein the controller is provided with a compression controller which compresses the other control programs to secure a storage region for the write-control program when the write-control program is rewritten by the rewriting portion.

11. The control device according to claim 3, wherein the controller is provided with a compression controller which compresses the other control programs to secure a storage region for the write-control program when the write-control program is rewritten by the rewriting portion.

12. The control device according to claim 4, wherein the controller is provided with a compression controller which compresses the other control programs to secure a storage region for the write-control program when the write-control program is rewritten by the rewriting portion.

13. The control device according to claim 5, wherein the controller is provided with a compression controller which compresses the other control programs to secure a storage region for the write-control program when the write-control program is rewritten by the rewriting portion.

14. The control device according to claim 6, wherein the controller is provided with a compression controller which compresses the other control programs to secure a storage region for the write-control program when the write-control program is rewritten by the rewriting portion.

15. The control device according to claim 7, wherein the controller is provided with a compression controller which compresses the other control programs to secure a storage region for the write-control program when the write-control program is rewritten by the rewriting portion.

16. The control device according to claim 8, wherein the controller is provided with a compression controller which compresses the other control programs to secure a storage region for the write-control program when the write-control program is rewritten by the rewriting portion.

17. A method of effective use of a memory which is mounted on a control device having a nonvolatile memory in which inherent data is written, comprising:
storing a plurality of control programs which include a writing control program for writing the inherent data into the nonvolatile memory; and
deleting the stored writing control program after the inherent data is stored into the nonvolatile memory by executing the writing control program.
